(19) United States
(12) Patent Application Publication
(10) Pub. No.: US 2025/0066150 A1
(43) Pub. Date: Feb. 27, 2025

(54) SHEET STATE DETECTION DEVICE AND IMAGE FORMING SYSTEM

(71) Applicant: Konica Minolta, Inc., Tokyo (JP)

(72) Inventor: Kunihiko KANOU, Tokoname-shi (JP)

(21) Appl. No.: 18/797,634

(22) Filed: Aug. 8, 2024

(30) Foreign Application Priority Data
Aug. 23, 2023 (JP) 2023-135365

(51) Int. Cl. B65H 7/14; B65H 5/06; G03G 15/00

(52) U.S. Cl. CPC B65H 7/14; B65H 5/062; G03G 15/6502; B65H 2404/14; B65H 2553/41

(57) ABSTRACT

Disclosed is A sheet state detection device including: a first conveyor that conveys a sheet; a second conveyor that is arranged on a downstream side relative to the first conveyor and conveys the sheet; and a detector that is arranged between the first conveyor and the second conveyor and detects a sheet state. A contact width that is at least one of a first contact width and a second contact width has a length equal to or greater than a width of a detection range of the detector, the firsts contact width being a contact width when the first conveyor contacts a sheet surface, and the second contact width being a contact width when the second conveyor contacts the sheet surface, and the detector is arranged such that the detection range is within the contact width in a width direction of the sheet.

### CROSS REFERENCE TO RELATED APPLICATIONS

The present invention claims priority under 35 U.S.C. § 119 to Japanese Application No. 2023-135365, filed on Aug. 23, 2023, the entire contents of which being incorporated herein by reference.

### BACKGROUND OF THE INVENTION

### Technical Field

The present invention relates to a sheet state detection device and an image forming system.

### Description of Related Art

Conventionally, in a sheet conveyance apparatus, an image forming apparatus, or the like, a technique is known for detecting a sheet state of a sheet being conveyed. The detected sheet state is, for example, a sheet position including a leading end position, a trailing end position, and a side end position of the sheet. The detected sheet state includes sheet physical properties such as thickness, moisture percentage, rigidity, surface properties, and electric resistance. Among these detected sheet states, there is a sheet state whose detection accuracy is greatly affected by the sheet posture. The sheet posture includes warpage, wrinkling, and undulation of the sheet.

Therefore, in order to prevent the occurrence of the failure in the sheet conveyance, means for holding the sheet being conveyed in an intended posture is provided.

For example, a configuration has been disclosed in which a distance-measuring sensor for measuring the distances to the sheet surface is provided between an upstream roller and a downstream roller (see, for example, Japanese Unexamined Patent Publication No. 2021-127227). The configuration described in Japanese Unexamined Patent Publication No. 2021-127227 is capable of maintaining an appropriate amount of deflection of the sheet by controlling the rotation speeds of the upstream and downstream rollers based on the amount of deflection of the sheet.

Furthermore, a configuration is disclosed in which a detection member that detects a load current value of a drive member that drives a downstream roller is provided (see, for example, Japanese Unexamined Patent Publication No. 2021-181357). In the configuration described in Japanese Unexamined Patent Publication No. 2021-181357, first, the amount of deflection of the sheet is grasped based on a load current value of the drive member, and speed control 1 of the upstream roller is performed. Thereafter, when the load current value reaches a predetermined value, the configuration described in Japanese Unexamined Patent Publication No. 2021-181357 performs speed control 2 of the upstream roller. Thus, the configuration described in Japanese Unexamined Patent Publication No. 2021-181357 prevents the sheet from being excessively bent.

### SUMMARY OF THE INVENTION

However, each of the configurations described in Japanese Unexamined Patent Publication No. 2021-127227 and Japanese Unexamined Patent Publication No. 2021-181357 is a configuration in which the rotation speed of the roller is corrected in accordance with the amount of deflection after the deflection occurs. Therefore, in the configurations described in Japanese Unexamined Patent Publication No. 2021-127227 and Japanese Unexamined Patent Publication No. 2021-181357, the deflection amount varies during conveyance, and the detection accuracy of the sheet state is affected. Furthermore, since the configurations described in Japanese Unexamined Patent Publication No. 2021-127227 and Japanese Unexamined Patent Publication No. 2021-181357 do not include a configuration for suppressing the width direction bending of the sheet, it is difficult to maintain a stable sheet posture.

An object of the present invention is to provide a sheet state detection device and an image forming system capable of accurately detecting a sheet state by reducing detection variation of the sheet state.

To achieve at least one of the abovementioned objects, according to an aspect of the present invention, a sheet state detection device reflecting one aspect of the present invention includes: a first conveyor that conveys a sheet; a second conveyor that is arranged on a downstream side in a conveyance direction of the sheet relative to the first conveyor and conveys the sheet; and a detector that is arranged between the first conveyor and the second conveyor and detects a sheet state of the sheet, wherein a contact width that is at least one of a first contact width and a second contact width has a length equal to or greater than a width of a detection range of the detector, the firsts contact width being a contact width when the first conveyor contacts a sheet surface of the sheet, and the second contact width being a contact width when the second conveyor contacts the sheet surface of the sheet, and the detector is arranged such that the detection range is within the contact width which has the length equal to or greater than the width of the detection range in a width direction of the sheet.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating a schematic configuration of an image forming system according to the present embodiment,

FIG. 2 is a functional block diagram illustrating a control structure of the image forming system according to the present embodiment,

FIG. 3 is a plan view illustrating an example of a configuration of the sheet state detection device,

FIG. 4 is a diagram illustrating an example of a state in which deflection occurs in a sheet being conveyed in the configuration illustrated in FIG. 3,

FIG. 5A is a plan view illustrating another example of the configuration of the sheet state detection device, and FIG. 5B is a side view illustrating the another example of the configuration of the sheet state detection device,

FIG. 6A is a plan view illustrating another example of the configuration of the sheet state detection device, and FIG. 6B is a side view illustrating the another example of the configuration of the sheet state detection device,

FIG. 7A is a plan view illustrating another example of the configuration of the sheet state detection device, and FIG. 7B is a side view illustrating the another example of the configuration of the sheet state detection device; and

FIG. 8A is a plan view illustrating another example of the configuration of the sheet state detection device, and FIG. 8B is a side view illustrating the another example of the configuration of the sheet state detection device.

### DETAILED DESCRIPTION

Hereinafter, one or more embodiments of the present invention will be described with reference to the drawings. However, the scope of the invention is not limited to the disclosed embodiments.

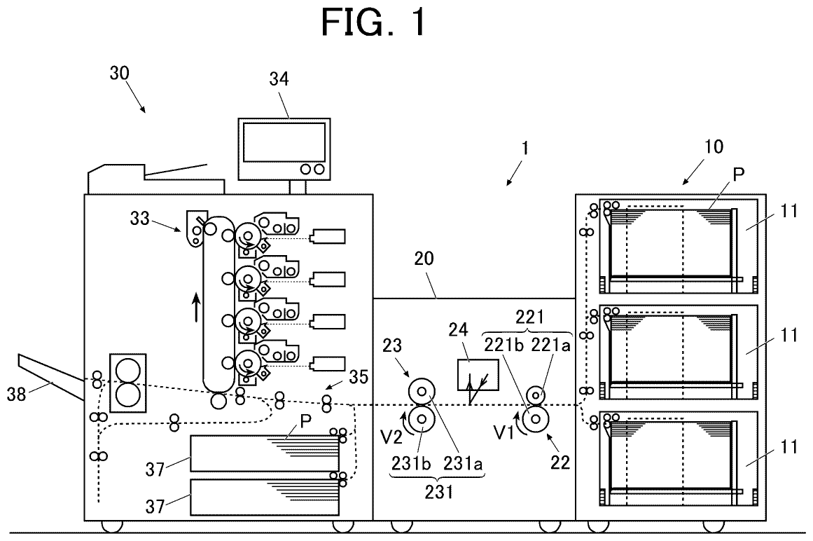

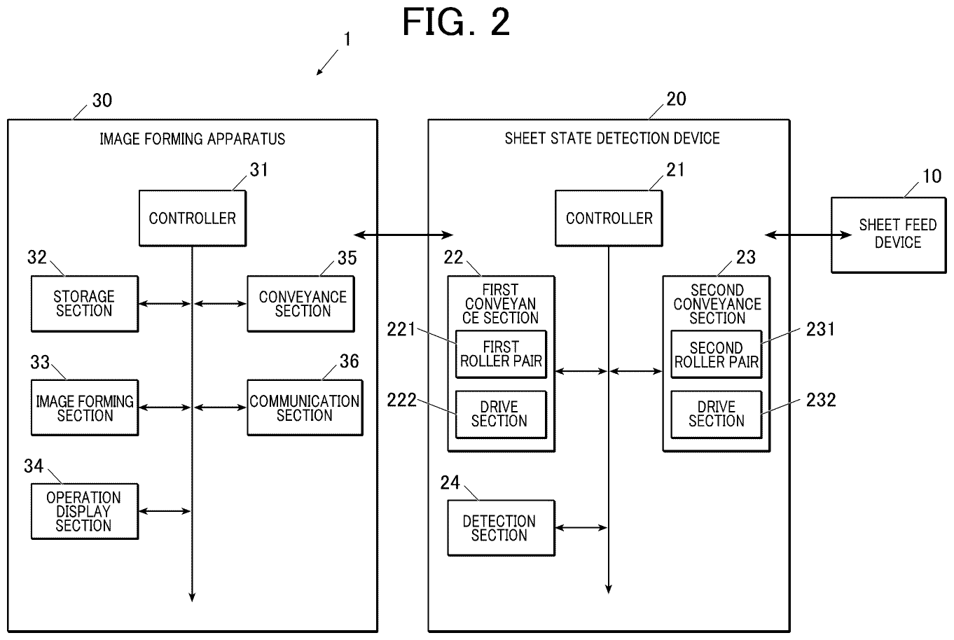

As illustrated in FIG. 1 and FIG. 2, the image forming system 1 according to the present embodiment includes a sheet feed device 10, a sheet state detection device 20, and an image forming apparatus 30. In the image forming system 1, the sheet feed device 10, the sheet state detection device 20, and the image forming apparatus 30 are connected in this order along a conveyance direction of the sheet P.

The sheet feed device 10 includes a plurality of sheet feed trays 11 and a sheet feed means (not illustrated) and feeds a sheet of paper P stored in a sheet feed tray 11 to the sheet state detection device 20. The sheet feed means is composed of, for example, a sheet feed roller, a separation roller, a sheet feed or separation rubber, a sending roller and the like. Each of the sheet feed trays 11 stores sheets P for each type (sheet type, basis weight, sheet size, and the like) of the sheets P. The sheet feed device 10 conveys the sheets P to the sheet state detection device 20 one by one from the top of the sheets P stored in each sheet feed tray 11.

The sheet state detection device 20 is connected to a subsequent stage of the sheet feed device 10. The sheet state detection device 20 includes a controller 21, a first conveyance section 22 (first conveyor), a second conveyance section 23 (second conveyor), and a detection section 24 (detector).

The controller 21 includes a central processing unit (CPU) and a memory and controls the entire sheet state detection device 20. The CPU is a control circuit constituted by a multi-core processor or the like that executes control of each section described above and various kinds of arithmetic processing in accordance with a program. Each function of the sheet state detection device 20 is exhibited by the CPU executing a program corresponding to each function. The memory is a high-speed accessible main storage device that temporarily stores a program and data as a work area. For the memory, for example, a dynamic random access memory (DRAM), a synchronous DRAM (SDRAM), a static random access memory (SRAM), or the like is adopted.

The first conveyance section 22 includes a first roller pair 221 and a drive section 222. The first roller pair 221 includes a pair of first rollers 221a and 221b that nip and convey the sheet P. The drive section 222 is, for example, a motor, and drives and rotates the first roller pair 221. The first conveyance section 22 nips a sheet P conveyed from the upstream side (the sheet feed device 10 side) with a first roller pair 221 and conveys the sheet P to the downstream side (the second conveyance section 23 side).

The second conveyance section 23 includes a second roller pair 231 and a drive section 232. The second conveyance section 23 is arranged on a downstream side in a conveyance direction of the sheet P with respect to the first conveyance section 22. The second roller pair 231 includes a pair of second rollers 231a and 231b that nip and convey the sheet P. The drive section 232 is, for example, a motor, and drives and rotates the second roller pair 231. The second conveyance section 23 nips the sheet P conveyed from the upstream side (the first conveyance section 22 side) with a second roller pair 231 and conveys the sheet P to the downstream side (the image forming apparatus 30 side).

Since the first roller pair 221 and the second roller pair 231 are rotated by the respective different drive sections, the rotation speeds thereof can be individually set.

The detection section 24 is arranged between the first conveyance section 22 and the second conveyance section 23, and detects a sheet state of the sheet P. The detection section 24 is, for example, a moisture percentage sensor for detecting the moisture percentage contained in the sheet P. The moisture percentage sensor emits light-emitting diode (LED) light having a specific wavelength, for example, in a range of Φ30, and detects the moisture percentage contained in the sheet P based on the reflectance from the surface of the sheet. The reflectance of the LED light changes when there is an inclination, a wrinkle, a swell, or the like in the detection range of the sheet surface to be irradiated. Therefore, the moisture percentage sensor may erroneously detect the moisture percentage. The detection section 24 may be a sensor that detects an edge of the sheet P. Furthermore, the detection section 24 may be a sensor that detects physical properties (such as surface properties) of the sheet P different from the moisture percentage.

The image forming apparatus 30 is connected to a subsequent stage of the sheet state detection device 20. The image forming apparatus 30 includes a controller 31, a storage section 32, an image forming section 33, an operation display section 34, a conveyance section 35, and a communication section 36. The image forming apparatus 30 forms an image on a sheet P of which the sheet state has been detected by the sheet state detection device 20.

The controller 31 includes a CPU and a memory and controls the entire image forming apparatus 30. The CPU is a control circuit constituted by a multi-core processor or the like that executes control of each section described above and various kinds of arithmetic processing in accordance with a program. Each function of the image forming apparatus 30 is achieved by the CPU executing a corresponding program. The memory is a high-speed accessible main storage device that temporarily stores a program and data as a work area. For the memory, for example, a DRAM, an SDRAM, an SRAM, or the like is adopted.

The storage section 32 is a large-capacity auxiliary storage device that stores various programs including an operating system and various types of data. As the storage, for example, a hard disk, a solid state drive, a flash memory, a read-only memory (ROM), or the like is adopted.

The image forming section 33 forms an image on the sheet P conveyed from the sheet state detection device 20 or the sheet P fed and conveyed from a sheet feed tray 37 of its own device. The image forming section 33 forms an image on the sheet P using a known image forming process of an electrophotographic method including, for example, charging, exposing, developing, transferring, and fixing.

The operation display section 34 includes a touch panel, a numeric keypad, a start button, a stop button and the like, and is used for displaying various kinds of information and inputting various instructions. The user can set sheet information such as the size and type of the sheet P stored in each sheet feed tray 37 via the operation display section 34.

The conveyance section 35 includes a plurality of conveyance rollers arranged on a conveyance path. First, the conveyance section 35 conveys to the image forming section 33, the sheet P conveyed from the sheet state detection device 20 or the sheet P fed from the sheet feed tray 37 of its own device. Next, the conveyance section 35 ejects the sheet P, on which the image has been formed by the image forming section 33, to the sheet ejection tray 38.

The communication section 36 transmits and receives various setting values, various information items required for operation timing control, and the like to and from other devices (the sheet feed device 10, the sheet state detection device 20, and the like).

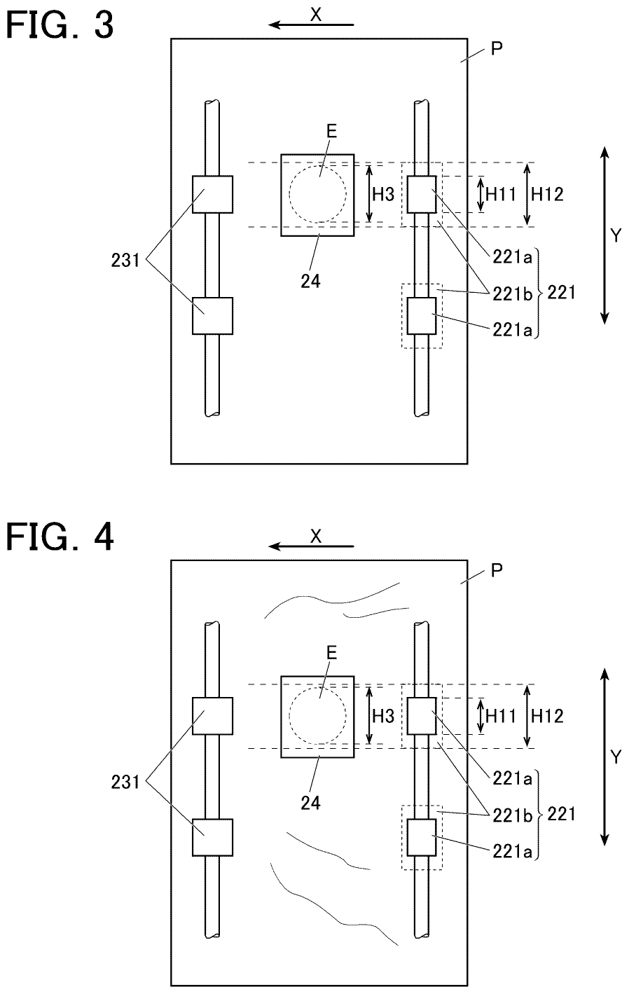

Next, a detailed configuration of the sheet state detection device 20 will be described with reference to FIG. 3. Note that the X direction in the drawings is the conveyance direction of the sheet P, and the Y direction is the width direction of the sheet P.

The first contact width is a contact width when the first conveyance section 22 contacts the sheet surface of the sheet P. The first contact width is a contact width of at least one of the pair of first rollers 221a and the 221b. The contact width is the length of a portion in contact with the sheet surface in the width direction (Y direction). In the example illustrated in FIG. 3, the first roller 221a and the 221b have a cylindrical shape. Therefore, the first contact width is the length of each of the first rollers 221a and the 221b in the width direction.

As illustrated in FIG. 3, the first contact width H12 of the lower first roller 221b is longer than the first contact width H11 of the upper first roller 221a. The first contact width H12 of the lower first roller 221b is equal to or greater than the width H3 of the detection range E of the detection section 24. The width H3 of the detection range E is the length of the detection range E in the width direction.

The detection section 24 is arranged such that the detection range E is within the first contact width H12 that is longer than or equal to the width H3 of the detection range E in the width direction of the sheet P.

FIG. 4 illustrates an example of a state in which deflection occurs in the sheet P being conveyed in the configuration illustrated in FIG. 3. FIG. 4 illustrates a state in which deflection occurs in a range other than the vicinity of the detection range E of the sheet P being conveyed. That is, in the configuration shown in FIG. 3, it can be seen that deflection does not occur in the vicinity of the detection range E of the sheet P being conveyed.

A plurality of the first roller pairs 221 and a plurality of the second roller pairs 231 (each plurality is two in FIG. 3) are each arranged intermittently in the width direction of the sheet P. Note that as each roller pair, instead of arranging a plurality of roller pairs intermittently in the width direction, a stout roller pair having no gap in the width direction may be used. With the use of the stout roller pair, the first contact width can reliably cover the width H3 of the detection range E of the detection section 24. However, the configuration using the stout roller pair has a problem that a risk of occurrence of a conveyance failure or a wrinkle due to a corner fold at the time of entry of the leading end of the sheet is increased. That is, in the configuration using the stout roller pair, as a result, it is difficult to stably detect the sheet state. Therefore, in the present embodiment, a plurality of roller pairs are arranged intermittently in the width direction. The number of roller pairs arranged intermittently in the width direction may be three or more.

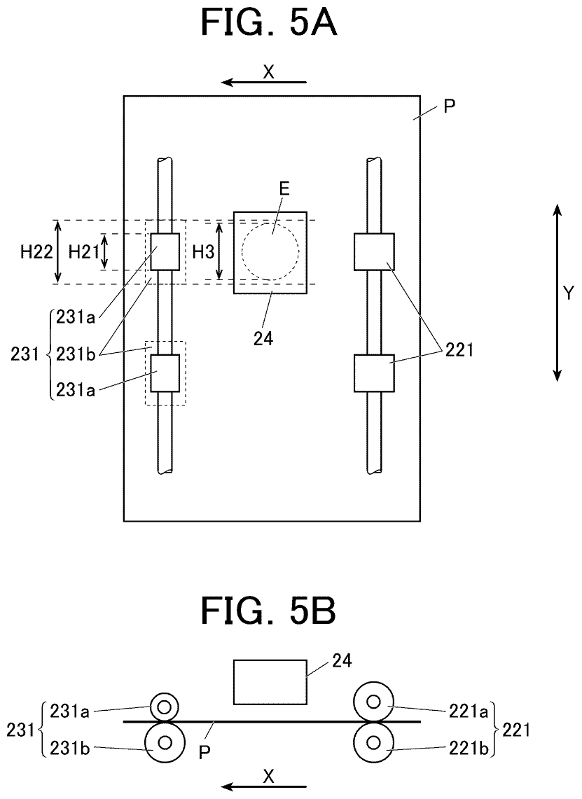

Note that FIG. 3 illustrates, as an example, a configuration in which the first contact width is equal to or greater than the width H3 of the detection range E of the detection section 24, but the present invention is not limited thereto. For example, as illustrated in FIG. 5A and FIG. 5B, the second contact width may be equal to or greater than the width H3 of the detection range E of the detection section 24. Note that FIG. 5A is a plan view illustrating a configuration in which the second contact width is equal to or greater than the width H3 of the detection range E. FIG. 5B is a side view of the configuration illustrated in FIG. 5A. The second contact width is a contact width when the second conveyance section 23 contacts the sheet surface of the sheet P. The second contact width is a contact width of at least one second roller of the pair of second rollers 231a and the 231b. In the example illustrated in FIGS. 5A and 5B of the figure, the second rollers 231a and 231b have a cylindrical shape. Therefore, the second contact widths are the width direction lengths of the respective second rollers 231a and 231b.

As illustrated in FIG. 5A, the second contact width H22 of the lower second roller 231b is longer than the second contact width H21 of the upper second roller 231a. The second contact width H22 of the lower second roller 231b is equal to or greater than the width H3 of the detection range E of the detection section 24.

The detection section 24 is arranged such that the detection range E is within the second contact width H22 that is equal to or longer than the width H3 of the detection range E in the width direction of the sheet P.

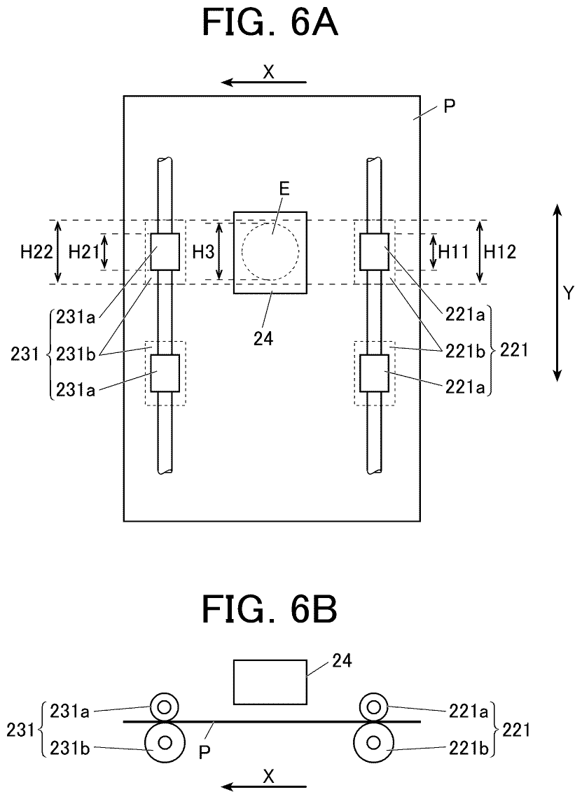

Note that both of the first and second contact widths H12 and H22 may be equal to or greater than the width H3 of the detection range E of the detection section 24. That is, any configuration may be adopted as long as at least one of the first and second contact widths H12 and H22 is greater than or equal to the width H3 of the detection range E. FIG. 6A and FIG. 6B illustrate an example of a configuration in which the first and second contact widths H12 and H22 are equal to or greater than the width H3 of the detection range E. Note that FIG. 6A is a plan view illustrating a configuration in which the first and second contact widths H12 and H22 are equal to or greater than the width H3 of the detection range E. FIG. 6B is a side view of the configuration illustrated in FIG. 6A.

The second conveyance section 23 is set to have a higher conveyance speed of the sheet P than the first conveyance section 22. That is, the conveyance speed V2 of the second conveyance section 23 is set to be higher than the conveyance speed V1 of the first conveyance section 22 (V2>V1). Thus, the second conveyance section 23 can convey the sheet P while pulling the sheet P. Therefore, the second conveyance section 23 can prevent the occurrence of sheet deflection in the conveyance direction. That is, the posture of the sheet surface is not broken even if the sheet P tries to droop due to its own weight or twists. Therefore, the detection section 24 can stably detect the sheet state.

The detection section 24 detects a sheet state of the sheet P being conveyed. Specifically, the detection section 24 detects the sheet state of the sheet P being conveyed by at least one of the first conveyance section 22 and the second conveyance section 23.

As described above, the image forming system 1 according to the present embodiment includes the first conveyance section 22 and the second conveyance section 23 that convey a sheet, and the detection section 24. The second conveyance section 23 is arranged on the downstream side in the conveyance direction of the sheet relative to the first conveyance section 22. The detection section 24 is arranged between the first conveyance section 22 and the second conveyance section 23 and detects a sheet state of the sheet. At least one of the first contact width and the second contact width has a length greater than or equal to a width of a detection range of the detection section 24. The first contact width is a contact width when the first conveyance section 22 contacts the sheet surface of the sheet. The second contact width is a contact width when second conveyance section 23 contacts the sheet surface of the sheet. The detection section 24 is arranged such that the detection range is within a contact width that is a length greater than or equal to a width of the detection range in a width direction of the sheet.

Therefore, according to the image forming system 1 of the present embodiment, it is possible to suppress the occurrence of sheet deflection, in particular, in the width direction of the sheet. Thus, the sheet posture can be stabilized, so that variation in detection of the state of the sheet can be reduced. Therefore, it is possible to accurately detect the sheet state.

The first conveyance section 22 includes a first roller pair 221 formed of a pair of first rollers 221a and 221b that nips and conveys the sheet. The first contact width is a contact width of at least one of the pair of first rollers 221a and the 221b.

Therefore, it is possible to suppress the occurrence of sheet bending with a simple configuration. Thus, the sheet posture can be stabilized, so that the state of the sheet can be accurately detected.

Furthermore, the second conveyance section 23 includes a second roller pair 231 including a pair of second rollers 231a and 231b that pinch and convey the sheet. The second contact width is a contact width of at least one second roller of the pair of second rollers 231a and the 231b.

Therefore, it is possible to suppress the occurrence of sheet bending with a simple configuration. Thus, the posture of the sheet can be stabilized, so that the state of the sheet can be accurately detected.

In addition, the second conveyance section 23 has a higher conveyance speed of the sheet than the first conveyance section 22.

Therefore, since the sheet can be conveyed while being pulled, it is possible to prevent the sheet from being bent in the conveyance direction. Therefore, the sheet state can be stably detected.

The detection section 24 detects the physical properties of the sheet.

The physical properties of the sheet are likely to be influenced by the sheet posture at the time of detection. Therefore, even in a configuration that is likely to be influenced by the sheet posture, the sheet posture can be stabilized. Therefore, even in a configuration that is likely to be influenced by the posture of the sheet, the state of the sheet can be accurately detected.

The detection section 24 detects a sheet state of the sheet being conveyed.

The posture of the sheet being conveyed tends to collapse. Therefore, even in a situation in which the sheet posture tends to collapse, the sheet posture can be stabilized. Therefore, even in a situation in which the sheet posture is likely to be collapsed, the sheet state can be accurately detected.

Although the present invention has been specifically described above based on the embodiments, the present invention is not limited to the above-described embodiments and can be modified without departing from the spirit and scope thereof.

For example, in the embodiment described above, the first contact width H12 of the lower first roller 221b is equal to or greater than the width H3 of the detection range E of the detection section 24, but the present invention is not limited thereto. For example, the first contact width H11 of the upper first roller 221a may be greater than or equal to the width H3 of the detection range E of the detection section 24.

However, the sheet P is likely to droop downward due to its own weight. Therefore, it is more preferable that the first contact width H12 of the lower first roller 221b be equal to or greater than the width H3 of the detection range E. Setting the first contact width H12 of the lower first roller 221b to be equal to or greater than the width H3 of the detection range E can more reliably stabilize the posture of the sheet P.

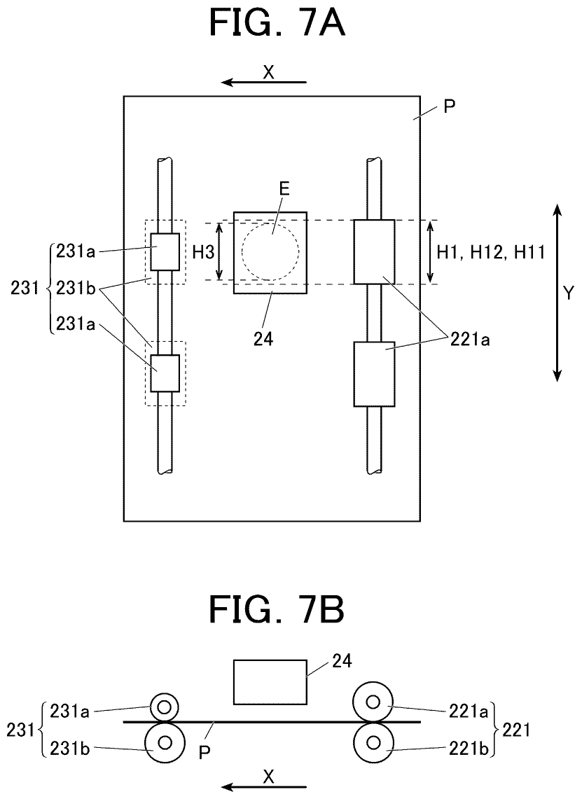

Furthermore, although the first contact width is the contact width of at least one of the pair of first rollers 221a and 221b in the embodiment described above, it is not limited thereto. For example, the first contact width may be the contact width of all of the first rollers 221a and 221b forming the first roller pair 221. That is, the first contact width H1 is the first contact width H12 of the lower first roller 221b and the first contact width H11 of the upper first roller 221a. FIG. 7A and FIG. 7B illustrate an example of a configuration in which the first contact width H1 is the contact widths H11 and H12 of all the first rollers 221a and 221b forming the first roller pair 221. Note that FIG. 7A is a plan view illustrating a configuration in which the first contact width H1 is the contact widths H11 and H12 of all the first rollers 221a and 221b forming the first roller pair 221. FIG. 7B is a side view of the configuration illustrated in FIG. 7A.

As described above, setting the first contact width to be the contact widths of all the first rollers 221a and 221b forming the first roller pair 221 can more surely stabilize the sheet posture. As a result, the sheet state can be accurately detected.

Furthermore, in the example illustrated in FIG. 5A and FIG. 5B, the second contact width H22 of the lower second roller 231b has the length greater than or equal to the width H3 of the detection range E of the detection section 24 but is not limited thereto. For example, the second contact width H21 of the upper second roller 231a may be greater than or equal to the width H3 of the detection range E of the detection section 24.

However, the sheet P is likely to droop downward due to its own weight. Therefore, it is more preferable that the second contact width H22 of the lower second roller 231b is equal to or greater than the width H3 of the detection range E. Setting the second contact width H22 of the lower second roller 231b to be equal to or greater than the width H3 of the detection range E can more reliably stabilize the posture of the sheet P.

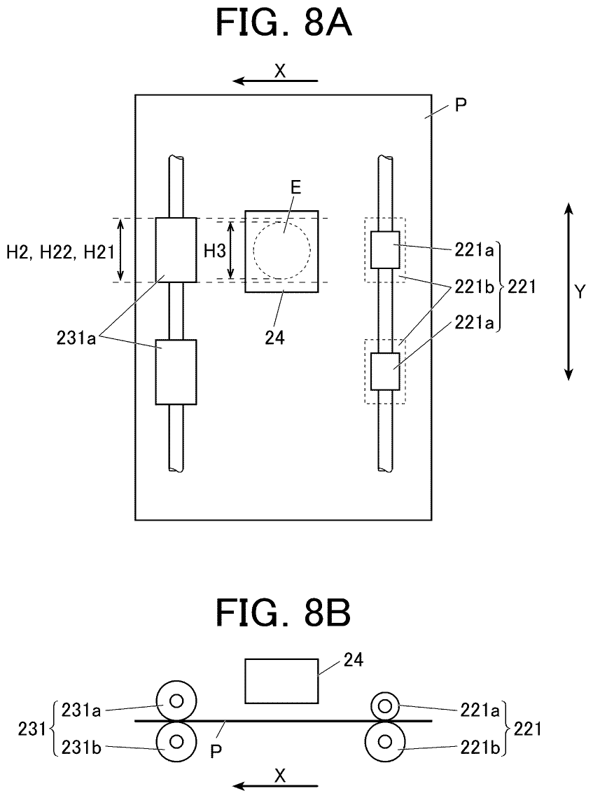

Furthermore, in the example illustrated in FIGS. 5A and 5B, the second contact width is the contact width of at least one of the pair of second rollers 231a and 231b but is not limited thereto. For example, the second contact width may be the contact widths of all the second rollers 231a and 231b of the second roller pair 231. That is, the second contact width H2 is the second contact width H22 of the lower second roller 231b and the second contact width H21 of the upper second roller 231a. FIG. 8A and FIG. 8B illustrate an example of a configuration in which the second contact width H2 is the contact widths H21 and H22 of all the second rollers 231a and 231b forming the second roller pair 231. Note that FIG. 8A is a plan view illustrating a configuration in which the second contact width H2 is the contact widths H21 and H22 of all the second rollers 231a and 231b forming the second roller pair 231. FIG. 8B is a side view of the configuration illustrated in FIG. 8A.

As described above, setting the second contact width to be the contact widths of all the second rollers 231a and 231b forming the second roller pair 231 can more surely stabilize the sheet posture. As a result, the sheet state can be accurately detected.

Further, the contact widths of all the rollers forming the first roller pair 221 and the second roller pair 231 may be equal to or greater than the width H3 of the detection range E of the detection section 24. Thus, the posture of the sheet can be further stabilized. As a result, the sheet state can be accurately detected.

Besides, the detailed configuration of each device and the detailed operation of each device constituting the image forming system can be appropriately modified without departing from the spirit and scope of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. A sheet state detection device comprising:
a first conveyor that conveys a sheet;
a second conveyor that is arranged on a downstream side in a conveyance direction of the sheet relative to the first conveyor and conveys the sheet; and
a detector that is arranged between the first conveyor and the second conveyor and detects a sheet state of the sheet, wherein
a contact width that is at least one of a first contact width and a second contact width has a length equal to or greater than a width of a detection range of the detector, the firsts contact width being a contact width when the first conveyor contacts a sheet surface of the sheet, and the second contact width being a contact width when the second conveyor contacts the sheet surface of the sheet, and
the detector is arranged such that the detection range is within the contact width which has the length equal to or greater than the width of the detection range in a width direction of the sheet.

2. The sheet state detection device according to claim 1, wherein
the first conveyor includes a first roller pair including a pair of first rollers that nip and convey the sheet, and
the first contact width is the contact width of at least one first roller of the pair of first rollers.

3. The sheet state detection device according to claim 1, wherein
the second conveyor includes a second roller pair including a pair of second rollers that nip and convey the sheet, and
the second contact width is the contact width of at least one second roller of the pair of second rollers.

4. The sheet state detection device according to claim 2, wherein the first contact width is a contact width of all the first rollers forming the first roller pair.

5. The sheet state detection device according to claim 3, wherein the second contact width is a contact width of all the second rollers forming the second roller pair.

6. The sheet state detection device according to claim 1, wherein the second conveyor has a higher conveyance speed of the sheet than a conveyance speed of the first conveyor.

7. The sheet state detection device according to claim 1, wherein the detector detects a physical property of the sheet.

8. The sheet state detection device according to claim 1, wherein the detector detects the sheet state of the sheet that is being conveyed.

9. An image forming system comprising:
the sheet state detection device according to claim 1; and
an image forming apparatus that forms an image on the sheet of which the sheet state has been detected by the sheet state detection device.
